(19) United States
(12) Patent Application Publication
(10) Pub. No.: US 2008/0016565 A1
(43) Pub. Date: Jan. 17, 2008

(54) Compliance Assessment And Security Testing Of Smart Cards

(76) Inventor: Alan Mushing, Wincham (GB)

Correspondence Address: BAKER BOTTS L.L.P., 30 ROCKEFELLER PLAZA, 44TH FLOOR, NEW YORK, NY, 10112-4498, US

(21) Appl. No.: 11/675,697

(22) Filed: Feb. 16, 2007

Related U.S. Application Data
(63) Continuation of application No. PCT/US05/29347, filed on Aug. 17, 2005.
(60) Provisional application No. 60/602,293, filed on Aug. 17, 2004.

(51) Int. Cl. G06F 11/00

(52) U.S. Cl. 726/22

(57) ABSTRACT

A compliance assessment and security testing process provides assurance that a vendor's smart card product complies with a card association's security guidelines and is approved for use in a smart card electronic payment system under a card association's brand name. A certificate of compliance is assigned to the product if approved. The security guidelines are updated as new security threats and developing attack potential are recognized and product certifications are accordingly updated. When security vulnerabilities are discovered in the vendor's smart card product, risk analysis is conducted to determine if the vulnerabilities pose an unacceptable level of risk to the member banks.

### CROSS-REFERENCE TO RELATED APPLICATIONS

This application claims the benefit of U.S. provisional patent application No. 60/602,293 filed on Aug. 17, 2004, which application is hereby incorporated by reference herein in its entirety.

### BACKGROUND OF THE INVENTION

Smart card technology is fast becoming commonplace in our culture and daily lives. A smart card is a card that is embedded with either a microprocessor and a memory chip or only a memory chip with non-programmable logic. The microprocessor card can add, delete, and otherwise manipulate information on the card, while a memory-chip card (for example, pre-paid phone cards) can only undertake a pre-defined operation. Smart cards, unlike magnetic stripe cards, can carry all necessary functions and information on the card. Therefore, they do not require access to remote databases at the time of the transaction.

Smart cards, which are also generally referred to by the industry as “microprocessor cards” or “chip cards”, offer greater memory storage and security of data than a traditional magnetic stripe cards. Smart cards may have up to 8 kilobytes of RAM, 346 kilobytes of ROM, 256 kilobytes of programmable ROM, and a 16-bit microprocessor. A smart card uses a serial interface and receives its power from external sources like a card reader. The processor uses a limited instruction set for applications such as cryptography. The smart cards are used for a variety of applications, especially those that have cryptography built in, which require manipulation of large numbers. Thus, smart cards have been the main platform for cards that hold a secure digital identity. The most common smart card applications are:

Credit cards

Electronic cash

Computer security systems

Wireless communication

Loyalty systems (like frequent flyer points)

Banking

Satellite TV

Government identification

Smart cards designed for specific applications may run proprietary operating systems. Smart cards designed with the capability to run multiple applications usually run MULTOS or Java Card.

Smart cards are an ideal method for electronic money management. Payment cards including GeldKarte, Mondex, Chipper, Quick etc. convert a given sum of money into bits and write them directly into the card's memory, whereas credit cards such as Eurocard, MasterCard, Visa and American Express use data and passkeys of the cardholder together with protocols such as SET (Secure Electronic Transactions) to guarantee secure payment.

The microprocessor on the smart card is there for security. The host computer and card reader actually “talk” to the microprocessor. The microprocessor controls access to the data on the card. If the host computer read and wrote the smart card's random access memory (RAM), it would be no different than a diskette.

Delivering security—i.e. ensuring access is granted only for authorized usage by authorized cardholders—is the fundamental attribute of smart cards. The effectiveness of smart cards in delivering security is one of the reasons they have been so widely adopted, especially in financial services and mobile phones, why the growth of smart cards has been explosive, and why their usage is expected to expand rapidly for other applications such as personal identity cards, health, transport and access to pay TV/entertainment.

As in any field, security standards do not stand still. There will always be those who for fraudulent, ethical or experimental reasons seek to break security shields. As in any field, it is also true that the notion of eternal security against every conceivable (and inconceivable) situation may be impracticable and that there is a trade-off between the last fraction of a percent security and cost.

Consideration is now being given to compliance assessment and security testing of smart cards. Attention is directed to all components in smart card solution, namely—chip, card, operating system and application software, terminals, and personalization of cards, network interface validation & terminal integration. Attention is directed in particular to a system and method for common risk assessment and security certification of all types of electronic payment cards marketed or deployed by a card association.

### SUMMARY OF THE INVENTION

The present invention provides a compliance assessment and security testing process for certifying that a vendor's smart card product complies with a card association's security guidelines and is approved for use in a smart card electronic payment system under a card association's brand name. The security guidelines are updated as new security threats and developing attack potential are recognized and product certifications are accordingly updated. When security vulnerabilities are discovered in the vendor's smart card product, risk analysis is conducted to determine if the vulnerabilities present an acceptable or unacceptable level of risk to the member banks. A risk analysis report may be prepared for use by the member banks.

The compliance assessment and security testing process is applicable to all types of smart card products irrespective of form factor or vendor. Using the testing process, each branded smart card product type deployed in a smart card electronic payment system may be made to conform to the card association's security requirements.

The compliance assessment and security testing process may be conducted by the card association in partnership with the product vendors. The card association may continually monitor threats, attacks, and security developments in the smart card industry and accordingly update its security guidelines for smart card products. The updated security guidelines are provided to product vendors so that they can design and build conforming smart card products. The vendor products are tested to determine if the vendor has adequately taken threats into account in the design of the product. Conforming or compliant products may be issued a certificate of compliance. Products that are deemed to have acceptable or tolerable vulnerabilities may be issued a combinational certificate of compliance. Products that are that have unacceptable vulnerabilities are denied a certificate of compliance. Previously certified products may be retested and recertified as the security guidelines are updated in response to newly recognized threats, attacks, and risks.

Further features of the invention, its nature and various advantages will be more apparent from the accompanying drawings and the following detailed description.

### BRIEF DESCRIPTION OF THE DRAWINGS

FIG. 1 is a schematic illustration of the components of two smart card products that can be certified using a compliance assessment and security testing solution in accordance with the principles of the present invention.

FIG. 2 is a flow diagram illustrating exemplary subprocesses of a compliance assessment and security testing solution for smart card products in accordance with the principles of the present invention.

FIG. 3 is flow diagram illustrating exemplary steps in a compliance assessment and security testing solution for smart card products in accordance with the principles of the present invention.

### DETAILED DESCRIPTION OF THE INVENTION

The present invention provides a compliance assessment and security testing (“CAST”) solution or certification process for certifying that a vendor's smart card product is fit or approved for secure use in the electronic payments industry. The CAST solution may be applied to smart card products that conform to common industry-wide chip card specifications (e.g., EMV Integrated Circuit Card Specifications), which are designed to ensure that all chip cards will operate with all chip-reading terminals, regardless of location, financial institution, or manufacturer. The CAST solution covers multiple parties—an electronic payment solution provider or card association (e.g., MasterCard), card vendors and manufacturers, and card issuers or acquirers (e.g., member banks), which may be involved in an implementation of a smart card electronic payment system.

In one application, which is shown in FIG. 2, the CAST solution is applied to a vendor's smart card product that is intended for deployment or marketing under a card association's brand name (e.g., MasterCard). If sufficient assurance is demonstrated and no exploitable vulnerabilities have been discovered, the card association may issue a CAST certificate number for the product to the vendor. When vulnerabilities are discovered, further analysis may be conducted to determine if the vulnerabilities pose an unacceptable level of risk to the member banks. If the discovered vulnerabilities do not pose an unacceptable level of risk, the card association may issue a Conditional CAST Certificate for the product to the vendor.

The CAST solution is applicable to all types of smart card products. The CAST solution ensures that, irrespective of form factor or vendor, each branded smart card product used in a smart card electronic payment system conforms to the card association's security requirements.

The CAST solution is designed to reflect the structure of the smart card industry, taking into account the relationships between the component suppliers of smart card products, their development processes, and the fact that chip migrations are currently underway. Further, the CAST solution reflects the latest developments in security evaluation methodology in the smart card industry, and marries independent evaluations with internal security testing. This flexibility may allow the card association (e.g., MasterCard) to maintain high levels of security assurance whilst minimizing the financial burden on vendors.

The CAST solution is complementary to and may be used in conjunction with other solutions that the card association may use for smart card quality assurance or certification (e.g., MasterCard's Card Type Approval program for smart card conformance to M/Chip technical specifications, Card Quality Management (CQM) program for card quality assurance and reliability, and Bureau Certification program for reviewing logical security requirements at chip personalizers).

The card association may use the CAST solution for mandatory evaluation of each smart card implementation regardless of the card form factor or vendor. Each component of the branded smart card (e.g., the integrated circuit or chip, the operating system (OS) and the applications) is evaluated.

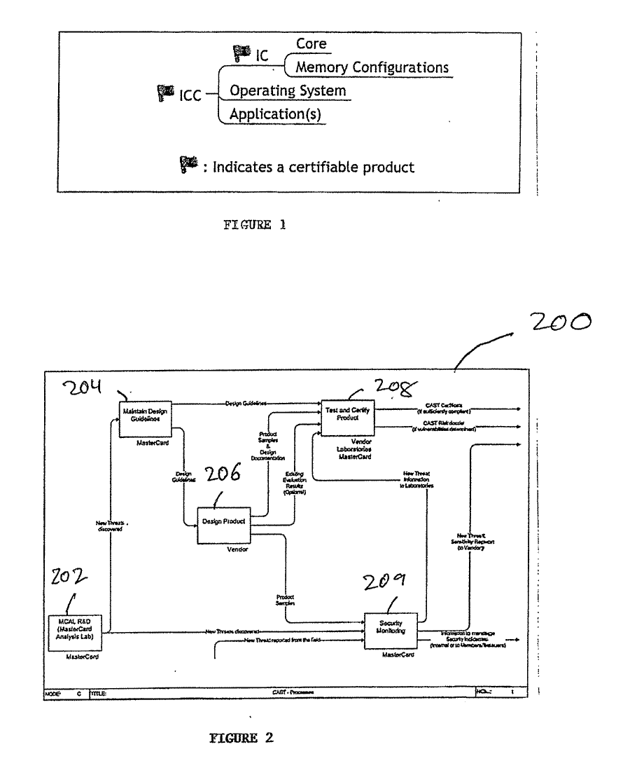

The CAST solution recognizes that a smart card is a composite of an application built on an operating system, which is built on an integrated circuit. The CAST solution processes reflect this by awarding certificates at different levels. The CAST solution is applicable to two principal groups or levels of certifiable products —Integrated Circuit (IC) and Integrated Circuit Card (ICC). See FIG. 1. Each of these groups of certifiable products is viewed by the CAST solution as including a set of components. A certifiable IC product, for example, is viewed as including an IC core and a memory configuration component. A certifiable ICC product is viewed as additionally including the operating system and application(s) components. A set of similar variations of a product, such as an IC core with various memory configurations can be assessed as a single product subject to certification and covered by a single certificate by the CAST solution.

For assessment of the IC product, the CAST solution considers the security of the actual integrated circuit used in the smart card product. The CAST solution may require a high degree of assurance in the IC core component security functions that are designed to effectively deal with known attack methods that include threats such as reverse engineering, information leakage and fault induction. The CAST solution takes into account the security of the product design, development and delivery processes. The CAST solution advantageously leverages evaluation work already performed by vendors, which may be supplemented with additional external evaluation or with internal evaluation by the card association (e.g., by MasterCard's internal Analysis Laboratory (MCAL)).

For assessment of the ICC product (i.e. card assessment), the CAST solution evaluates the security of the card manufacturers who develop operating systems. An important feature evaluated is how the card manufacturers build upon the security of the chip to provide the overall security of the smart card. This evaluation may include evaluation of secondary defenses against potential physical vulnerabilities and correctness of implementation. Further, the CAST solution for certification of a product card may consider specific requirements for virtual machines, such as MULTOS or JavaCard operating systems. The nature of such operating systems requires close evaluation to ensure the security of the smart card. The CAST solution may include (1) logical testing of the platform to verify that the implementation conforms to specifications and does not contain known weaknesses, (2) physical penetration testing of the platform to ensure that the implementation has countermeasures against potential weaknesses, and (3) testing of the application loading mechanism, e.g., Global Platform, to verify conformance to specifications and defenses against known vulnerabilities.

The CAST solution for certification of the ICC product also includes assessment of the application component. Application assessment is only carried out in conjunction with or after assessment of the IC and operating system components in the ICC product. Applications are not assessed without a corresponding IC and operating system implemented on a card. For application assessment, the CAST solution evaluates application developers, and ensures that the developed applications follow the security guidelines of the chip and the operating system designers. The CAST solution includes implementation reviews for financial applications (e.g., including MChip) to ensure a high level of assurance. These reviews include code review and penetration testing. When there is more than one application on a card with a proprietary operating system or a virtual machine, assurance is sought to demonstrate the firewalls between the applications, and/or the lack of object sharing. A risk assessment may also be conducted for some applications. The risk assessment may include integration of off-card components if they perform an important role in the security process.

In the CAST solution, security assurance of the product is obtained by security evaluations, which may be performed by reputable external evaluation laboratories using the card association's security guidelines (e.g., MasterCard Security Guidelines) and/or externally developed testing tools. The card association may leverage previous work performed by the vendor or the member. The card association may recognize the methodology used in some formal evaluation schemes such as Common Criteria, but may accept only full evaluation reports as evidence of such.

The CAST solution reflects a partnership between the card association and product vendors, and seeks to minimize unnecessary cost and time spent in evaluation work. The card association may support the CAST solution with its own internal R&D program to ensure the optimum awareness of threats and defenses while maintaining confidential relationships with external laboratories and vendors.

The output of the CAST solution is a certificate chain that identifies a single approval path from chip vendor through card manufacturer to member bank, including where applicable, independent application developers. Smart card product vendors may be required to present the CAST certificate number to a member bank as proof that their product has been evaluated and approved via the CAST solution as meeting the security guidelines of the card association. In instances where a potential security defect or vulnerability in a vendor product is found, a CAST certificate may not be granted. The vendor may be fully informed of the details of any such security defect or vulnerability. The card association may work with the vendor to adequately inform smart card issuers of the potential security defect or vulnerability so that their risks or exposure can be properly assessed. Further, the card association may work with the vendor to put a plan in place to introduce a revised product that reduces the vulnerability.

The security features of electronic payment applications (e.g. MasterCard's MChip Application), which are commonly deployed in smart cards, allow for a number of risk management measures. The risk management measures may be detailed in the payment application specifications (e.g. MChip Specifications) and/or in industry guidance such as the EMV Security Guidelines that are published by EMVCo. These risk management measures are supplemented or extended by the CAST solution, which may make smart card security evaluation a necessary part of the vendors product design and development process. When a vendor sells a product they may be required to explain the testing that has been carried out in order to satisfy the CAST solution assurance and testing processes.

Security testing in the CAST solution may be continuously and timely updated as new security threats and developing attack potential are recognized. The level of testing in the CAST solution can be continuously increased to reflect ‘state of the art’ attack potential. Consequently, newly certified smart card products will always offer a higher level of protection against the newest threats than earlier certifications. Member banks or issuers may check the date of the CAST certification of a vendor's smart card product for information on whether the product is secure from new security threats. The CAST solution may advantageously allow the electronics payment industry to remain one step ahead of attackers.

The CAST solution recognizes that there is no such thing as perfect security. The primary assets on a smart card are the secret keys and the PIN. The secondary assets include parameters such as security counters (e.g. Application Transaction Counter). An attack with a high enough Work Function (Skills, Equipment and Time) may well succeed in breaching card security and access the primary assets or secondary assets on a smart card. The CAST solution is designed to identify vulnerabilities in these terms to fit into a proper system risk analysis for a member bank or issuer.

A member bank or issuer may develop or implement a secure smart card payment system by including defenses at all levels of vulnerabilities. The issuer may develop strategies for prevention, detection and recovery. An attacker may be motivated by a desire for either publicity or reward. The member bank or issuer may plan incident management procedures for attackers of either motivation, and implement appropriate security measures to prevent the risk/reward equation from tipping in favor of the attacker.

In instances where a vendor product does not receive a CAST certificate, the vendor may be left in a position to explain the reason for lacking a CAST certificate. The vendor may offer guidance about the potential risks to an issuer's implementation plans. Risks may sometimes be mitigated by other security measures to a level that is acceptable to the member bank or issuer.

FIG. 2 shows an exemplary set of processes that are deployed in a CAST solution 200 implemented by a card association (e.g., MasterCard). CAST solution 200 may be designed to enable member banks to carry out knowledge based risk assessment for their smart card programs or implementations, and to facilitate coordinated continuous improvements in ensuring the security of financial transactions. CAST solution 200 also is designed to highlight vendor's product having state-of-the-art security functionality.

In CAST solution 200, at step 202, an analysis lab associated with the card association, continuously monitors threats and security developments in the smart card industry. The analysis lab may conduct this monitoring activity by itself and/or in association with other security laboratories. The analysis lab may conduct research and development to identify new threats, attacks and security evaluation methodology.

The analysis lab may incorporate relevant results of its threat and security monitoring, and R & D activities in security guidelines that includes updateable information for the design of secure smart card products and process security monitoring. The security guidelines may be grouped by product type (e.g., Design Guidelines for ICs, Design Guidelines for Operating Systems, and Design Guidelines for Applications). The card association may maintain the security guidelines to provide up to date guidance to vendors for the design of secure smart card products. At step 204, the security guidelines are given to vendors to assist them in the development of their smart card products and/or to external test laboratories to assist them in evaluating smart card products within a CAST solution framework. The card association may make the latest design guidelines available online (See e.g., www.mastercard.com\.------------.)

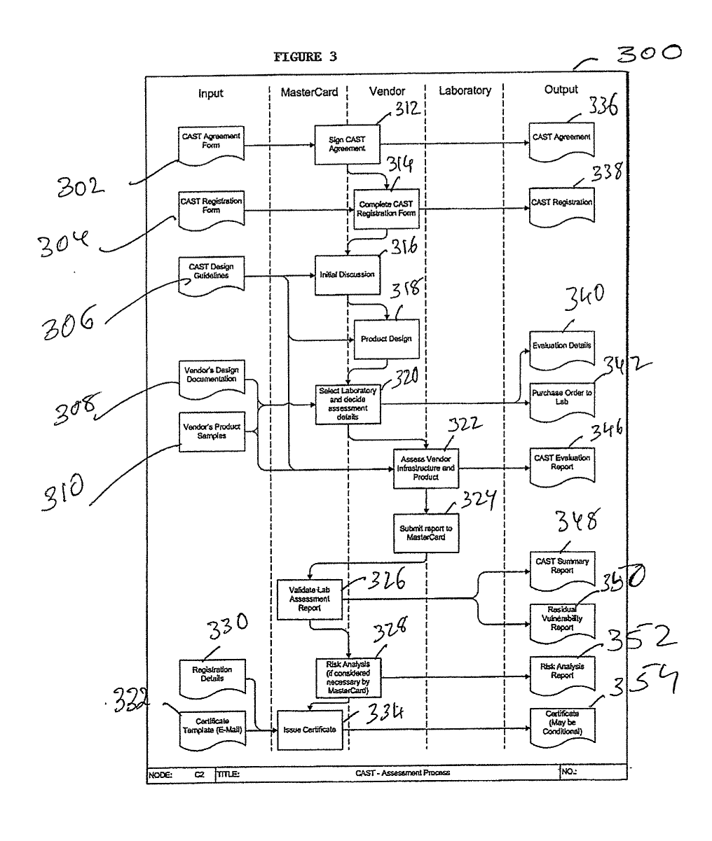

At step 206, a vendor may design his/or her smart card product according to the guidelines provided by the card association. Next at a “test and certify product” step 208 in CAST solution 200, the vendor's product, and if appropriate related processes, are assessed to determine if the vendor has adequately taken threats and attacks into account in the design of the product. The assessment may involve a detailed testing and certification process 300, which is shown in FIG. 3. As a result of the assessment at step 208, the card association may issue a certificate or a conditional certificate for the vendor product. If no residual vulnerabilities are discovered at step 208, the card association issues a CAST certificate. If residual vulnerabilities are discovered at step 208, the card association may issue a conditional CAST certificate if a risk analysis indicates that the discovered vulnerabilities pose a manageable risk or tolerable risk. The risk analysis may be performed at step 208. (See e.g., process 300 FIG. 3).

The certificates issued by the card association can confirm that the vendor's product(s) identified on the certificate have undergone CAST assessment and that a risk analysis on discovered residual vulnerabilities has been performed. The card association may publish that such a CAST certificate is conditional. As a result, the vendor may be compelled to disclose the information contained in the risk analysis report to member banks (and other parties) to whom the vendor offers to sell the product covered by the conditional CAST certificate. This disclosure may be necessary to ensure the vendor's customers can accommodate the remaining risks in their risk assessments and allow them to introduce sufficient countermeasures in their electronic payment systems against these remaining risks.

CAST solution 200 may include an optional security monitoring step 209, at which the card association operates an ongoing process to check certified products against newly identified attacks and risks to ensure sufficient risk management. Where appropriate or necessary, the card association may inform vendors who have CAST certified products about newly discovered vulnerabilities of their certified products. This may allow the vendors to eliminate the risk and to support their customer's risk management programs.

FIG. 3 shows the exemplary steps of testing and certification process 300 that may be used at step 206 in CAST solution 200. The various parties involved or associated with the smart card product implementation, including the card association, the product vendor, and external and internal laboratories, may perform the steps of process 300. FIG. 3 indicates the responsibility for carrying out each step as well as the necessary forms, and resulting or required documents for each process step.

With reference to FIG. 3, at preliminary step 312, the card association and a vendor may sign a confidentiality agreement (312). As a result of this process step, both parties may receive a signed version (336) of an CAST agreement form (302). At step 314, the vendor may provide the card association details about the product intended for CAST assessment and related administrative information. The CAST registration details (338) may be provided by completing a standard CAST registration form 304. At optional step 316, the vendor and the card association may conduct initial discussions based on the completed CAST registration form 338 to reach a common understanding of the assessment process and the underlying information. The vendor may submit advance evidence for security assessments already carried out on the product, so the card association can prepare itself for an efficient initial discussions.

At step 318, if not already completed prior to the initiation process 200 or 300, the vendor may finalize the design of the product or makes changes to the product as a response to the requirements derived from the published CAST guidelines 306 (See e.g., step 204 FIG. 2). At step 318 processes may further include carrying out or amending self- or third-party assessment of the security performance of the product and the underlying development and production processes. Also at step 318, the vendor may provide product design documentation 308 and product samples 310 for testing.

In response, at step 320 the card association may select a laboratory for testing submitted vendor products 310, and determine the details of the assessment required. Step 320 also may involve discussion between the vendor and the card association to agree on the details of the assessment required. The details may include a list of mandatory assessments and selection of the laboratories to be used. Step 320 may involve a review by the card association of existing evidence about already performed security assessments of the product by the vendor or a third party. The vendor and card association may agree to take into account the needs and previous work done by the vendor. However, the card association may reserve the final decision about which minimum set of assessments are considered necessary within the CAST solution.

Step 320 may be performed at any suitable time after step 316 after the vendor and card association agree that the product has a sufficient maturity to prepare the assessment. Upon completion of step 320, purchase orders 342 may be placed with the selected testing laboratories and the minimum assessment details may be documented (340).

Next at step 322, the selected laboratories may perform the required assessment (340) of the vendor product and infrastructure. The assessment conducted by the selected laboratories may include physical testing of product samples, assessment of the design documentation and/or auditing of the Vendor's development and production processes. At step 324, the selected laboratories may submit lab assessment reports documenting the results directly to the card association or via the vendor.

At step 326, the card association validates the submitted lab assessment reports. The card association may critically review the lab assessment reports and may require further assessment, in which case process 300 can revert to step 320 for selection of laboratory and assessment details. If at step 316, the card association considers lab assessment reports provide sufficient assurance, the card association may prepare a CAST Summary Report (348). In cases where vulnerabilities have been discovered, a Residual Vulnerability Report (350) may be prepared as part of Summary Report 348.

Further, based on the critical review the lab assessment reports at step 326, a risk analysis of the vulnerabilities discovered may be performed at step 328. The vendor and the card association may preform risk analysis step 328 individually or jointly. In response to the risk analysis, the vendor may choose to remedy the discovered vulnerabilities and submit new samples or product versions for re assessment (e.g., at step 320).

If residual vulnerabilities are discovered at step 326, and the vendor decides not to remedy these vulnerabilities (step 328), the vendor and card association may jointly prepare a Risk Analysis report (352). Risk Analysis report 352 contains risk information for the card association's member banks intending to use the vendor's product. The card association may attempt to understand and take into account the vendor's wishes with respect to the contents of Risk Analysis report 351. However, the card association must reserve final authority over the contents of Risk Analysis report 352, so it can fulfill its obligations towards its member banks in providing them reliable information for a valid risk assessment of their smart card projects.

If the card association concludes that sufficient assurance has been demonstrated by step 328, and that no exploitable vulnerabilities have been discovered, at step 334 the card association may issue a CAST certificate (354) for the product to the vendor. If the card association concludes that vulnerabilities discovered are sufficiently covered by the Risk Analysis report 352 and do not constitute an unmanageable or intolerable risk for a member bank, the card association may issue a conditional CAST certificate for the product to the vendor. The certificates may be incorporate product registration details (330 or 338) and use electronic templates (322) for convenience in processing and electronic delivery. The card association may reserve the right not to issue any CAST certificate.

It will be understood that the foregoing is only illustrative of the principles of the invention, and that various modifications can be made by those skilled in the art without departing from the scope and spirit of the invention.

We claim:

1. A method for compliance assessment and security testing of a vendor's smart card product, the product intended for use under a card association's brand name in an electronic payment system, the card association having security guidelines for smart card product, the method comprising the steps of:
(a) monitoring threats, attacks, and security developments in the smart card industry;
(b) providing the card association's security guidelines that include updateable information for the design of secure smart card products based on step (a) to the vendor so that the vendor can design smart card products according to the card association's security guidelines;
(c) testing the vendor's smart card product to determine if the vendor has adequately taken threats into account in the design of the product; and
(d) issuing a certificate of compliance based on the results of step (c).

2. The method of claim 1 wherein vulnerabilities are discovered at step (c), the method further comprising the steps of:
(e) conducting risk analysis to determine the level of risk posed by the discovered vulnerabilities; and
(f) issuing a conditional certificate of compliance for the vendor product based on the results of step (e).

3. The method of claim 2 further comprising the step (g) of publishing information that the certificate of compliance is conditional.

4. The method of claim 1 further comprising the step (h) of conducting ongoing checks of the certified product against newly identified threats, attacks, and risks.

5. The method of claim 4 further comprising the step (i) of informing the vendor about vulnerabilities in a previously certified product that are newly discovered at step (h).

6. The method of claim 1 wherein step (c) comprises receiving informing from the vendor about security assessments already carried out on the product.

7. The method of claim 1 wherein step (c) further comprises evaluating the information received from the vendor about security assessments already carried out on the product, and accordingly conducting additional testing of the vendor's smart card product to determine if the vendor has adequately taken threats into account in the design of the product

8. The method of claim 1 wherein in response to the updated information in the security guidelines provided to the vendor at step (b), the vendor makes changes to the product.

9. The method of claim 1 wherein vulnerabilities are discovered at step (c) that are not remedied by the vendor, the method further comprising the steps (h) of preparing a Risk Analysis report.

10. The method of claim 9 further comprising the step (i) of providing the Risk Analysis report to the card association's member banks intending to use the vendor's product.
